(19) United States
(12) Patent Application Publication
(10) Pub. No.: US 2026/0065594 A1
(43) Pub. Date: Mar. 5, 2026

(54) System and Method for Training 3D Models Using Refined Generated Output Data

(71) Applicant: HL Acquisition, Inc. dba Hosta AI, Cambridge, MA (US)

(72) Inventors: Mica Arie-Nachimson, Cambridge, MA (US); Sathish Kumar Katukuri, Cambridge, MA (US); Brad Sheneman, Cambridge, MA (US); Wenzhe Peng, Cambridge, MA (US); Rachelle Villalon, Cambridge, MA (US)

(21) Appl. No.: 19/294,169

(22) Filed: Aug. 7, 2025

Related U.S. Application Data
(60) Provisional application No. 63/680,486, filed on Aug. 7, 2024.
(60) Provisional application No. 63/686,637, filed on Aug. 23, 2024.

(51) Int. Cl. G06T 17/20; G06F 3/04815; G06V 20/70

(52) U.S. Cl. CPC G06T 17/20; G06F 3/04815; G06V 20/70

(57) ABSTRACT

A comprehensive spatial AI platform for neural 3D reconstruction and built environment analysis integrates foundation models, deep learning methods, and spatial reasoning capabilities to provide expert knowledge of the physical world. The platform combines symbolic AI and machine learning to facilitate 3D semantics for insurance, real estate, construction, robotics, and other business applications. The system processes captured images, videos, or point clouds through neural networks with low compute requirements, incorporating device-agnostic advanced spatial intelligence that delivers geometric, semantic, and relational data. The platform includes proprietary training innovations, comprehensive measurement and semantic understanding, external sensor integration, human-in-the-loop quality assurance, and API integration for programmatic access. Advanced spatial reasoning capabilities enable property damage assessments, construction progress tracking, robotics navigation, and real-time applications including room dimension validation and automated repair estimates, supporting enterprise workflows across various industry segments while enabling productivity improvements and new value-added spatial AI use cases.

### CLAIM OF PRIORITY

This application claims priority under 35 U.S.C. § 119(e) to U.S. Patent Application Ser. No. 63/686,637, filed on Aug. 23, 2024, and to U.S. Patent Application Ser. No. 63/680,486, filed on Aug. 7, 2024, the entire contents of each of which are hereby incorporated by reference.

### TECHNICAL FIELD

The present invention relates to neural 3D reconstruction systems, artificial intelligence systems for 3D modeling, and spatial AI platforms for built environment analysis, and more particularly to systems and methods for improving the accuracy and applicability of AI-generated 3D models through iterative training using refined output data, deep learning methods for 3D reconstruction, semantic understanding of built environments, and foundation models for spatial reasoning in physical world applications.

### BACKGROUND

In the field of 3D modeling and spatial AI, the generation of accurate and detailed models is critical for various applications, including virtual reality, robotics, gaming, architecture, engineering, construction, insurance, real estate, property management, and other business-to-business and/or business-to-consumer applications operating in the physical built world. Traditionally, creating and refining these models has been a labor-intensive process, often requiring extensive manual input and large datasets of real-world examples.

While Large Language Models (LLMs) have shaped the foundations and infrastructure for the digital world, there exists a need for similar foundational infrastructure for understanding and analyzing the physical world. The built environment presents unique challenges requiring specialized spatial intelligence that can understand geometric, semantic, and relational data from images, videos, and 3D models to generate detailed building elements and logical representations of building data.

With the advent of AI-generated 3D models, there has been a significant shift towards using artificial intelligence to automate the creation of these models, thereby reducing the need for manual intervention and enabling the rapid development of complex structures. However, current approaches face several limitations including the need for large amounts of reconstruction data, requirements for manual refinement to meet application specifications, lack of comprehensive semantic understanding of built environments, insufficient integration of spatial reasoning capabilities, and limited ability to operate efficiently across diverse hardware platforms and input modalities.

The challenge lies in developing a comprehensive spatial AI platform that combines symbolic AI and machine learning to facilitate 3D semantics while providing device-agnostic advanced spatial intelligence. Such a system must be capable of processing diverse inputs including images in random order, video sequences, and point clouds while operating with low compute requirements and providing API-based access for enterprise integration.

What is needed in the art is a robust spatial AI platform that can train AI-generated 3D models using refined outputs while enabling advanced spatial reasoning for built environment-specific applications. This platform should provide foundation models and AI infrastructure that allows enterprises to leverage spatial intelligence for productivity improvements, quality enhancements, and new value-added use cases across various industry segments including insurance, real estate, construction, robotics, facility management, home improvement, and other industries that operate within the built environment.

### SUMMARY

The present invention provides a comprehensive spatial AI platform that integrates neural 3D reconstruction, deep learning methods, and foundation models for spatial reasoning to create world-class expert knowledge of the built environment. The platform combines symbolic AI and machine learning to facilitate 2D and 3D semantics. The spatial AI platform serves as the foundation and infrastructure for the physical world, analogous to how LLMs have shaped foundations for the digital world. The system is designed as a built environment-specific spatial AI platform that enhances three-dimensional perception and spatial reasoning across various industry segments through API-based access that works with images, video, 3D models, point clouds, text, and sound, accommodating both new and existing data with low compute requirements.

The system comprises a neural 3D reconstruction pipeline that processes captured images through deep learning algorithms to generate 3D geometry meshes. The system includes computer vision models that generate labeled images with semantic annotations, enabling detailed understanding of architectural elements and spatial relationships. The platform incorporates device-agnostic advanced spatial intelligence that delivers geometric, semantic, and relational data to generate detailed building elements and logical representations of building data.

The system further comprises an AI model generation module configured to generate initial 3D models based on input data, with enhanced spatial understanding of the built environment through 3D built-specific semantics at scale. This includes statistical and symbolic understanding that enables extraction of measurements, bill of materials, 3D models, and spatial reasoning capabilities. A model evaluation and adjustment module evaluates the generated 3D models and facilitates targeted adjustments, either manually or automatically, while leveraging semantic understanding and optional human-in-the-loop quality assurance. The platform includes advanced feature recognition and modeling capabilities that provide spatial and temporal comparison of specific regions identified through images or videos. This enables applications such as property damage assessment (before and after analysis), construction progress tracking for quality control, and spatial fitting analysis for objects within spaces. The system incorporates low compute, fast reasoning capabilities through foundation models that require minimal computation while creating rapid spatial reasoning. This enables real-time applications including property estimate acceleration, room dimension validation through measurement APIs, floor plan and 3D model generation, and robotics applications where mobile autonomous systems can navigate environments using preprocessed spatial metadata. The platform provides advanced spatial reasoning for property damage assessments, creating contextual understanding of damaged properties that serves as baseline for automated repair estimates. The system analyzes high-dimensional data to detect and classify various types of property damage using advanced algorithms that can automatically generate repair estimates based on insurance carrier guidelines. Integration capabilities include external sensor support for versatile inputs from various data sources including water damage sensors, electrical system monitors, noise sensors, gas leak detectors, radiation sensors, motion detectors, and other environmental monitoring systems. The platform can link to automated methods for managing inventories and property assessments through comprehensive metadata profiles.

The system supports continuous learning, allowing AI models to be updated and retrained as new data and user feedback become available, ensuring adaptive and effective operation over time while enabling enterprises to drive productivity improvements, quality enhancements, and new value-added spatial AI use cases.

The system incorporates comprehensive use case support across multiple industry segments. For insurance applications, the platform enables automated property damage assessment, repair estimate generation, augmented reality visualization for remote damage analysis, and fast customer claim processing with instant feedback during non-business hours. Real estate applications include room dimension certification for listings, virtual furniture fitting and placement, property condition assessment, and accurate space measurement from 2D photographs. Construction and facility management use cases encompass construction progress tracking for quality control, building information modeling (BIM) integration, facility maintenance analytics, automated inventory management through images and drones, and comprehensive building documentation for ongoing operations.

Robotics applications leverage the platform's low-compute spatial reasoning for autonomous navigation using preprocessed spatial metadata, warehouse management with package placement optimization, and mobile device integration for consumer applications such as furniture shopping with dimensional verification and augmented reality room visualization. The system's ability to quickly extract measurements and spatial intelligence enables certification of room dimensions, helping customers make informed decisions about accommodations, storage, or purchases. The platform supports both 3D virtual reality and augmented reality applications through lean metadata that can operate efficiently on consumer mobile devices.

Enterprise workflow optimization includes outsourcing spatial intelligence tasks to end users, reducing errors and turnaround times for instant customer satisfaction, and enabling new value-added spatial AI applications that were previously computationally intensive or required specialized hardware.

The system incorporates blockchain verification for input data authenticity, ensuring data integrity and preventing fraud in critical applications such as insurance claims and property assessments. The platform generates detailed outputs including measurements, floor plans, 3D models, bill of materials, quantity counts, damage assessments, property conditions and risks, and other analytical insights.

The spatial AI platform's 3D digital representation of interior and exterior spaces transcends basic geometric collections, recognizing deeper semantics and relationships within structures including positions and connections between spatial boundaries and architectural objects like interior partition and exterior walls, floors and floor types, tray ceilings, architectural doors, and windows, as examples. The system understands abstract elements including performance characteristics, cost analysis, material properties with thermal and solar characteristics, installation and operation processes, and human factors.

The platform enables transformation of two-dimensional images into three-dimensional virtual scenes, providing contextual understanding through neural networks and sophisticated spatial-based computer vision algorithms. This transformation capability supports diverse enterprise applications requiring spatial intelligence including object flow analysis through spaces, spatial relationship understanding, installation planning, material quantity estimation, and holistic scene impact assessment.

For temporal analysis applications, the system provides before-and-after damage comparison, construction progress monitoring, and spatial evolution tracking over time. The platform produces geometric and parametric 3D models from temporal changes in real-world environments, significantly reducing manual effort required for creating technical drawings and construction documentation. The system's device-agnostic design leverages advanced neural networks and computer vision algorithms to improve accuracy of environmental representations from existing reality capture technologies including LiDAR, photogrammetry, and time-of-flight cameras, resulting in unprecedented detail levels in floor plans, 3D models, and other generated outputs.

In some examples, a system for generating semantically labeled 3D models, comprising: a neural 3D reconstruction pipeline configured to process captured images into 3D geometry meshes; a computer vision module configured to generate labeled images with semantic annotations; an alignment module configured to integrate semantic labels into the 3D geometry to generate labeled 3D models; and a post-processing pipeline configured to output structured metadata describing spatial and semantic features of a built environment. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. In this example, the computer vision module identifies walls, ceilings, doors, windows, floors, and furniture objects. The structured metadata includes room dimensions, spatial relationships, and architectural classifications. The actions include an API interface for accessing labeled 3D models and semantic metadata programmatically.

In another example, a system for refining AI-generated 3D models, comprises a model evaluation module configured to detect discrepancies between generated 3D models and specification data; a user interface configured to present discrepancies and receive manual adjustments from a human reviewer; a metadata annotation system configured to record adjustment parameters and impacts; and a feedback pipeline configured to compile adjusted models into a training dataset for AI model retraining. Other embodiments of this aspect include corresponding computer systems, apparatus, and computer programs recorded on one or more computer storage devices, each configured to perform the actions of the methods. In this example, the user interface supports annotation, geometric correction, and semantic reclassification. The feedback pipeline tags training data with adjustment provenance and performance impact. The actions include a model retraining module configured to minimize loss between adjusted and generated outputs.

In still another example, a system for reconstructing room geometry from point cloud data, comprises a pointcloud processing module configured to assign semantic labels to 3D point cloud data from multiple frames; a coordinate inference module configured to determine coordinate alignment and scale factors; a geometric plane extraction module configured to identify signed planes from the point cloud data; and a zone-based reconstruction module configured to define room boundaries based on Boolean operations on validated zones. Other embodiments of this aspect include corresponding computer systems, apparatus, and computer programs recorded on one or more computer storage devices, each configured to perform the actions of the methods.

In this example, the coordinate inference module applies the transformation P_scene=S×R×(P_world−T). The pointcloud processing module assigns confidence scores to each point based on label consistency across frames. The zone-based reconstruction module subdivides bounding boxes using extended wall plane segments and validates zones based on signed distances.

In still another example, a system for training AI models for 3D reconstruction, comprising a training dataset comprising original and adjusted 3D models annotated with metadata; a training module implementing a mixed autoregressive and dense prediction transformer architecture; a proportional sampling component configured to weight training samples by data quality; and a loss function framework including geometric loss, semantic loss, and edge-aware smoothness regularization. Other embodiments of this aspect include corresponding computer systems, apparatus, and computer programs recorded on one or more computer storage devices, each configured to perform the actions of the methods.

The training module implements a two-phase training protocol that eliminates intermediate phases. The training module operates using half-precision training in bfloat16 format. The actions include a dataset generation module configured to produce labeled training data from photos and metadata.

In still another example, a system for querying reconstructed 3D environments using natural language, comprises semantic space model configured to associate architectural elements with spatial attributes and semantic labels; a natural language processing module trained on built environment terminology; and an API layer configured to interpret and respond to queries related to dimensions, structural relationships, accessibility, and building code compliance. Other embodiments of this aspect include corresponding computer systems, apparatus, and computer programs recorded on one or more computer storage devices, each configured to perform the actions of the methods.

In this example, the semantic space model supports queries across residential, commercial, and industrial building types. The API layer returns responses containing measurement values, classifications, and compliance status. The natural language processing module is fine-tuned on domain-specific construction and architecture datasets. The system of claim 21: A method for generating semantic segmentation masks from input images, comprising: receiving a captured image of a built environment; applying a vision transformer model to classify pixels into semantic categories; generating segmentation masks identifying architectural elements including walls, floors, ceilings, and openings; and storing semantic label data in association with 3D spatial coordinates derived from matching point cloud data. The segmentation masks are used to enhance accuracy in 3D model training by aligning labels with geometry. The input images are processed in random order and support multi-view aggregation. The actions include integrating segmentation outputs into a unified labeled 3D model through cross-view consistency checking.

In still another example, a method for refining 3D models using human-in-the-loop review, comprising, generating an initial 3D model using an AI-based reconstruction system; evaluating the model for discrepancies against design or specification data; presenting detected discrepancies via a user interface to a human reviewer; receiving manual corrections to geometry or semantic labels from the reviewer; annotating corrections with metadata describing adjustment type and rationale; and compiling the original and corrected models into a training dataset for model retraining. Other embodiments of this aspect include corresponding computer systems, apparatus, and computer programs recorded on one or more computer storage devices, each configured to perform the actions of the methods.

In this example, the metadata includes confidence level, reviewer ID, and quality impact score. Retraining uses a loss function weighted to emphasize human-corrected samples. The actions include presenting before-and-after comparison views to the reviewer for validation.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates a system architecture diagram showing the neural 3D reconstruction pipeline and modular training system with input/output data flows according to an embodiment of the present invention.

FIG. 2 illustrates the method steps for training 3D models using refined generated output data with neural reconstruction integration according to an embodiment of the present invention.

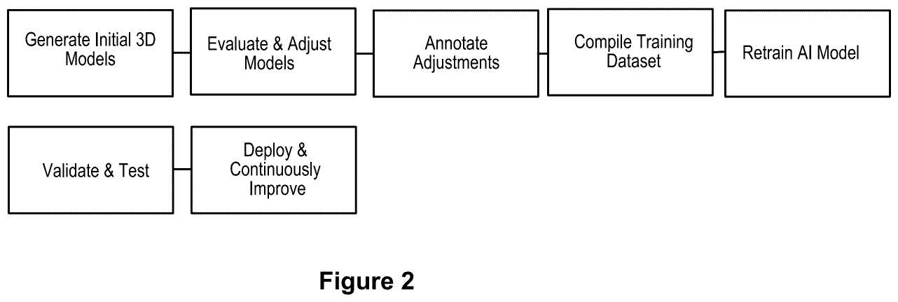

FIG. 3 is a diagram showing the zone-based geometric reconstruction process and spatial reasoning components according to an embodiment of the present invention.

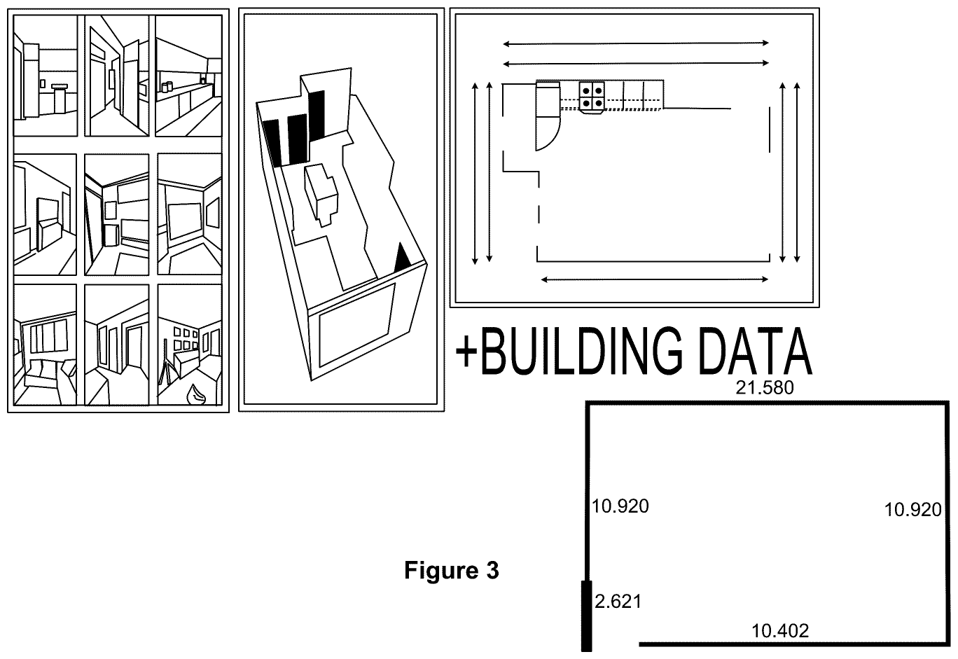

FIG. 4 is a visualization of the complete Neuro3D pipeline showing the flow from captured images through neural 3D reconstruction to labeled geometry and final output according to an embodiment of the present invention.

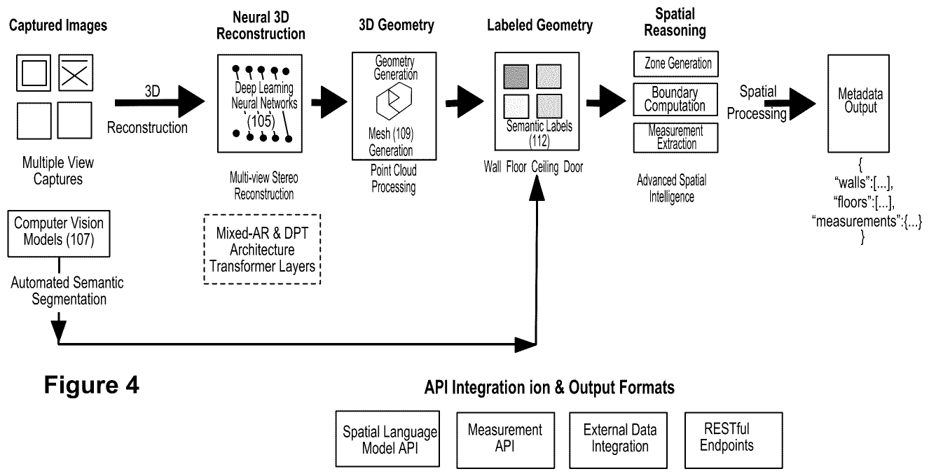

FIG. 5 depicts a process flow of the techniques described herein.

FIG. 6 depicts an example computing system, according to implementations of the present disclosure.

### DETAILED DESCRIPTION

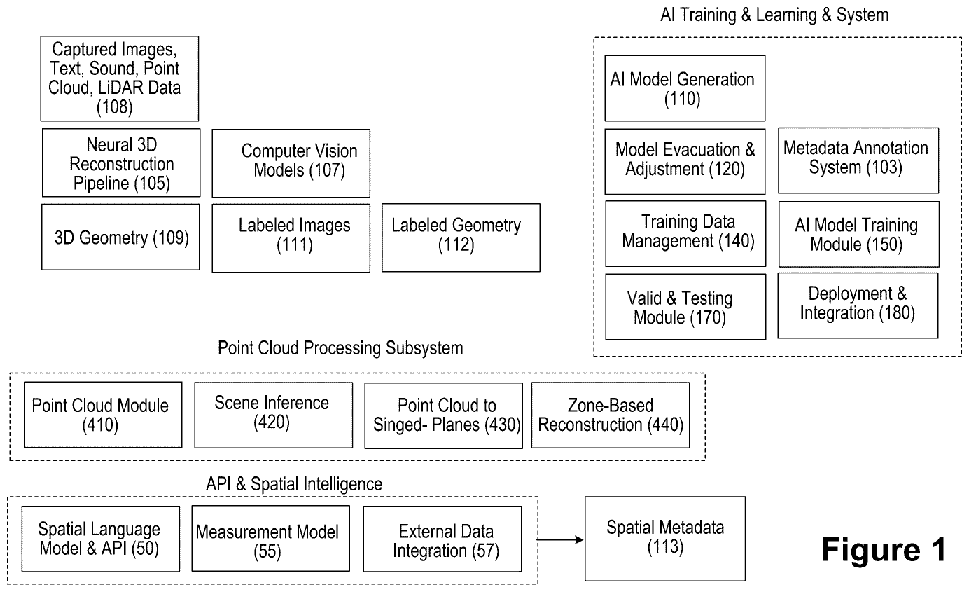

Referring to FIG. 1, the system 100 begins with a neural 3D reconstruction pipeline 105 that processes captured images using deep learning methods to generate detailed 3D geometries. This pipeline takes input captures (images) and processes them through neural networks specifically designed for 3D reconstruction tasks.

The neural 3D reconstruction component employs advanced deep learning algorithms including convolutional neural networks, transformer architectures, and geometric learning methods to convert 2D image inputs into accurate 3D geometric representations. The system processes multiple input images simultaneously and learns spatial relationships to generate comprehensive 3D captured environments.

The system incorporates computer vision models that generate labeled images with semantic annotations. These models identify and classify various elements within the captured scenes, including architectural components, structural elements, and objects. The labeled images serve as input to subsequent processing stages, providing semantic context that enhances the accuracy of 3D reconstruction. The neural 3D pipeline outputs include 3D geometry meshes that represent the spatial structure of captured environments, and labeled geometry that combines geometric information with semantic classifications. This labeled geometry serves as the foundation for further processing through the post-processing pipeline.

The system 100 processes various input data types including captured images 108 from cameras, mobile devices, or other imaging systems. The neural 3D reconstruction pipeline processes these images through deep learning algorithms to generate 3D geometry meshes 109 representing the spatial structure of captured scenes.

Computer vision models 107 work in conjunction with the neural reconstruction pipeline to generate labeled images 111 that include semantic annotations identifying architectural elements, structural components, and objects within the captured scenes. This semantic information is integrated with the geometric reconstruction to produce labeled geometry 112 that combines spatial and semantic understanding.

The post-processing pipeline converts the labeled geometry into structured metadata 113 representations that provide comprehensive descriptions of room layouts, architectural elements, and spatial relationships in a standardized format suitable for various applications including architectural modeling, virtual reality, and construction planning. The system outputs are designed for integration through application programming interfaces (APIs) that enable third-party applications and services to access the 3D reconstruction results, semantic understanding data, and measurement information. The structured data formats support programmatic access to geometric, semantic, spatial, and measurement information, facilitating integration with external systems and workflows. The API capabilities extend beyond data access to provide intelligent semantic analysis of spaces, enabling applications to query material properties, structural specifications, architectural standards, and contextual information about built environments.

The point cloud processing components function as a spatial language model (LM) 50 that enables intelligent querying of the built environment with comprehensive semantic understanding. This spatial LM capability allows users and applications to perform natural language queries about interior and exterior spaces, architectural elements, spatial relationships, environmental characteristics, precise measurements, and material specifications. The spatial language model can interpret queries about room dimensions, ceiling heights, wall thicknesses, material properties, structural elements, spatial adjacencies, geometric relationships, building code compliance, and accessibility requirements within the reconstructed 3D environment.

The system incorporates the ability to pull supplementary data from external sources and databases to enhance spatial understanding and provide comprehensive contextual information. This external data integration 57 can include building codes, material specifications, architectural standards, environmental regulations, accessibility requirements, and other relevant information that supplements the reconstructed geometric and semantic data. The API serves as both an access point for reconstruction results and as an interface for semantic space analysis, enabling applications to query not just what exists in a space, but also contextual information about building standards, material properties, compliance requirements, and functional characteristics.

The system incorporates comprehensive measurement capabilities that provide precise dimensional analysis of reconstructed spaces. Measurement functions include automatic calculation of room dimensions, wall heights, surface areas, volumes, clearances, and spatial relationships between architectural elements. The measurement system generates accurate real-world measurements by leveraging the coordinate system inference and scale factor determination capabilities, ensuring that all dimensional data is expressed in standard units suitable for architectural and construction applications.

The semantic understanding module provides detailed classification and analysis of architectural elements, materials, and spatial functions. This module identifies and categorizes walls, floors, ceilings, doors, windows, fixtures, and objects within the reconstructed environment while determining material properties, structural characteristics, and functional classifications. The semantic analysis extends beyond simple object recognition to include understanding of spatial relationships, accessibility features, building systems, and architectural styles.

The AI model generation module 110 is responsible for generating initial 3D models based on input data and parameters. This module employs machine learning algorithms, including but not limited to neural networks, generative adversarial networks (GANs), and transformer architectures, to create 3D representations from various input sources such as images, point clouds, LIDAR data, or textual descriptions.

The model evaluation and adjustment module 120 evaluates the 3D model output for accuracy and alignment with specified requirements. This module identifies discrepancies between the generated models and desired specifications through automated analysis and/or manual review processes. The system incorporates optional human-in-the-loop quality assurance capabilities that enable human experts to provide oversight, validation, and interactive refinement of AI-generated models. The human-in-the-loop functionality allows for expert review of reconstruction results, manual correction of semantic labels, geometric adjustments based on domain knowledge, and validation of measurement accuracy. This optional human oversight ensures that critical applications requiring high accuracy can benefit from human expertise while maintaining the efficiency of automated processing for standard workflows. Necessary adjustments are made to refine the models, ensuring they conform to specific requirements for 3D outputs and extended data such as semantic understanding, measurements, floor plans, and materials for both interior and exterior of buildings or non-buildings. The adjustment process can be fully automated, fully manual through human-in-the-loop interfaces, or hybrid approaches that combine automated processing with selective human review for quality-critical elements.

The metadata annotation system 130 documents all adjustments made to the 3D models, capturing important metadata that describes the nature and impact of the changes. This metadata includes, but is not limited to, adjustment type, magnitude of change, geometric modifications, texture alterations, semantic classifications, and performance impact metrics. The system can be used for back-annotation to and from a database 160.

The training data management module 140 compiles the adjusted and original models, along with their metadata, into a structured dataset for retraining the AI model. This module manages data versioning, ensures data integrity, and maintains relationships between original and refined model pairs.

The AI model training module 150 uses the compiled dataset to retrain or fine-tune the AI model, optimizing its ability to produce accurate and application-specific 3D models. The module implements several proprietary innovations that significantly improve upon existing training methodologies.

The training module employs a mixed autoregressive (AR) and dense prediction transformer (DPT) architecture for all training phases, eliminating the need for square image inputs or linear head configurations that limit conventional approaches. This architecture provides improved flexibility in handling variable input sizes and aspect ratios while maintaining computational efficiency. The mixed-AR component enables sequential processing of spatial information while the DPT component provides dense prediction capabilities for geometric reconstruction tasks. The system implements a novel two-phase training approach that removes traditional intermediate phases and modifies the initial and final training stages. This streamlined approach reduces training time while improving model convergence. Phase 1 focuses on initial feature learning with mixed-AR and DPT components, establishing fundamental spatial understanding and geometric relationships. Phase 3 concentrates on fine-tuning with production data and custom loss functions, optimizing the model for real-world deployment scenarios. The elimination of intermediate phases reduces computational overhead while focusing training on the most critical learning stages.

The module incorporates a proprietary implementation of half-precision training using bfloat16 format, optimized for the specific requirements of 3D model generation. This implementation provides memory efficiency benefits while maintaining numerical stability for geometric computations. The bfloat16 format is particularly well-suited for 3D reconstruction tasks as it preserves the dynamic range necessary for accurate spatial calculations while reducing memory footprint and computational requirements.

Rather than using equal weighting across datasets, the training module implements proportional dataset representation that weights training samples based on data quality, relevance, and production requirements. This approach ensures that higher-quality datasets have appropriate influence on model learning. The weighting system considers factors such as annotation accuracy, geometric precision, semantic completeness, and real-world applicability to optimize the training process. The module implements custom loss functions that account for both geometric accuracy and semantic correctness. The geometric loss component measures spatial accuracy and structural integrity, while the semantic loss ensures proper classification of architectural elements. The application-specific loss component optimizes for particular use cases, and the quality loss incorporates custom metrics for comprehensive model evaluation. The system includes a comprehensive data preprocessing pipeline that handles multiple input formats and applies proprietary transformations optimized for 3D reconstruction tasks. This pipeline includes noise reduction algorithms that filter out artifacts from scanning processes, coordinate system normalization that ensures consistent spatial orientation, and semantic label validation that verifies the accuracy and completeness of structural annotations. The preprocessing pipeline also handles format conversion between different 3D data representations and applies standardization procedures to ensure consistent input quality. The preprocessing pipeline incorporates an automated image segmentation module that provides semantic segmentation of input images to identify and classify structural elements, objects, and spatial regions. This segmentation module generates detailed masks that delineate boundaries between different semantic categories, enabling precise labeling of architectural elements such as walls, floors, ceilings, doors, windows, and objects within the captured scenes. The segmentation results are integrated with point cloud data to provide comprehensive semantic understanding across both 2D image and 3D spatial domains.

The training module incorporates several proprietary datasets including production data from real-world capture scenarios, capture application data optimized for mobile and handheld devices, and synthetic datasets generated through proprietary rendering pipelines. The production data provides real-world examples that improve model robustness, while the capture application data ensures compatibility with mobile scanning workflows. Open source datasets include additional semantic annotations and geometric validation, and the synthetic datasets provide controlled training examples with ground truth.

The system includes a specialized pipeline for generating training data from photos and metadata, incorporating automated camera pose estimation, multi-view stereo processing, semantic segmentation transfer, and quality validation and filtering. The camera pose estimation automatically determines the spatial relationship between multiple photographs while processing 3D geometry from image sequences. Semantic segmentation transfer applies learned semantic understanding to new scenes, and quality validation ensures that generated training data meets accuracy standards.

The training module implements custom data augmentation techniques specifically designed for 3D reconstruction tasks. Geometric augmentations preserve 3D relationships while introducing spatial variations that improve model robustness. Photometric augmentations maintain semantic consistency while varying lighting and appearance conditions to simulate real-world capture scenarios. Temporal augmentations for multi-frame inputs introduce temporal variations that help the model handle different scanning patterns and speeds. Scale and rotation augmentations with coordinate system awareness ensure that spatial transformations maintain geometric validity.

The system incorporates quality assessment metrics including Iterative Closest Point (ICP) metrics that measure geometric alignment accuracy between reconstructed and ground truth models, multi-scale Intersection over Union (IoU) that computes minimum, maximum, and median IoU scores across different spatial scales to assess reconstruction completeness, semantic consistency scores that evaluate the consistency of semantic labels across different views and scales, and production quality metrics that are custom designed to assess suitability for specific production applications. These quality metrics provide comprehensive feedback for model optimization and validation.

The system further incorporates advanced architectural improvements designed to enhance model performance and training efficiency. The training module implements overcomplete estimation techniques that provide redundant parameter estimation to improve robustness and accuracy. This includes direct camera parameter estimation that automatically determines camera intrinsics and extrinsics without requiring external calibration procedures, and direct depth estimation with gradient supervision that provides improved depth accuracy through gradient-based loss functions that enforce depth consistency across multiple views. The system employs a unified single decoder architecture with symmetric local and global attention mechanisms, replacing traditional dual-decoder approaches with asymmetric pairwise attention. This unified architecture reduces computational complexity while improving feature integration between local spatial details and global geometric understanding. The symmetric attention mechanism ensures balanced processing of both local geometric features and global spatial relationships, leading to more consistent and accurate 3D reconstructions. The system further supports alternating local and global attention patterns that can be dynamically configured based on processing requirements, enabling enhanced feature extraction and spatial understanding through alternating attention mechanisms that process local spatial details and global contextual information in sequential layers.

The training module incorporates advanced loss function components that enforce spatial consistency and geometric smoothness in generated 3D models. The system implements edge-aware smoothness regularization that preserves important geometric features while encouraging spatial coherence in reconstructed surfaces. This approach utilizes image gradients to identify edges and boundaries, applying reduced smoothing constraints at these locations to maintain sharp geometric features while promoting smoothness in homogeneous regions. The smoothness constraints are adaptively weighted based on local image content, ensuring that geometric detail is preserved where visually important while reducing noise in uniform areas.

The training module incorporates camera token integration capabilities that enable direct processing of camera parameter information within the attention mechanism framework. Camera tokens provide explicit representation of camera parameters and spatial relationships, allowing the attention mechanism to directly incorporate geometric constraints and multi-view relationships during feature processing. This integration enables more accurate geometric reconstructions by embedding camera parameter information directly into the model architecture rather than relying solely on external geometric constraints.

The training infrastructure incorporates cluster-based training with automated job submission through MLOps integration. This distributed training approach enables efficient utilization of computational resources by automatically scaling training across multiple processing units based on workload requirements. The MLOps integration provides automated model versioning, performance monitoring, and deployment pipelines that ensure consistent and reliable model updates.

The system includes a comprehensive reworking of data preprocessing pipelines optimized for list-based processing rather than traditional pairwise approaches. This list-based preprocessing enables more efficient batch processing of multiple related images or point clouds simultaneously, improving training throughput and enabling more sophisticated multi-view consistency checks. The preprocessing pipeline handles variable-length sequences of related spatial data while maintaining geometric relationships and semantic consistency across all elements in each list.

These innovations collectively provide significant improvements in training efficiency, model accuracy, and production readiness compared to conventional 3D reconstruction training methodologies.

The validation and testing module 170 rigorously tests the retrained AI model against a separate validation dataset to ensure it meets required standards. This module implements various metrics including geometric accuracy, semantic correctness, and application-specific performance indicators. The validation module incorporates optional human-in-the-loop quality assurance workflows that enable human experts to review validation results, identify edge cases requiring attention, and provide feedback for model improvement. The human oversight capabilities are designed to be scalable and optional, allowing organizations to implement varying levels of human review based on application requirements, accuracy needs, and available resources.

The deployment and integration module 180 deploys the validated AI model into production environments and integrates it into existing 3D modeling workflows. This module ensures seamless integration with existing systems and provides APIs for third-party integration. The system further incorporates comprehensive point cloud processing capabilities that work in conjunction with the AI model generation and training modules to provide enhanced geometric understanding.

The point cloud processing components comprise several interconnected modules. The point cloud processing module 410 processes raw point cloud data (format: N, W, H, 3) and integrates structural labels from multiple frames to produce unified labeled point clouds with confidence scores. The module implements multi-frame label consistency algorithms that assign confidence scores to each point based on label agreement across different captured frames. The scene coordinate system inference module 420 automatically determines proper coordinate system alignment and scale factors to ensure axis-aligned reconstruction in real-world units. This module transforms raw point map coordinate systems (world CS) into scene coordinate systems (scene CS) where reconstructed geometry is axis-aligned and expressed in real-world units.

The coordinate system transformation is expressed mathematically as: P_scene=S×R×(P_world−T), where P_scene represents points in scene coordinates, S is the scale factor, R is the rotation matrix aligning world_up_direction with Z-axis, P_world represents original point coordinates, and T is the translation vector.

The pointcloud-to-signed-planes module 430 extracts geometric planes from point cloud data, essential for defining structural surfaces such as walls. The zone-based reconstruction module 440 implements zone-based room boundary inference through zone generation that subdivides axis-aligned bounding boxes using extended wall plane segments to create cell-like zones through geometric intersection operations. Zone validation evaluates each zone to determine whether it represents an enclosed room area (valid zone) or exterior area (invalid zone) by analyzing signed distances of points within each zone to surrounding wall planes. Boundary computation computes room boundaries through Boolean union operations on valid zone polygons, providing robust handling of complex room geometries. Wall classification distinguishes between exterior wall segments (extracted from room boundary) and interior wall segments (validated through visibility sampling).

The quality assessment module 450 generates comprehensive metrics including approximation rates measuring the percentage of wall points within acceptable distance tolerances of reconstructed walls, providing quantitative feedback for the training system.

The point cloud processing outputs include metadata files with detailed room structure descriptions with measurements and semantic classifications accessible via API, metadata files with compatible data models and integrated measurement data for programmatic integration, web-compatible 3D visualization files with embedded semantic and measurement information for API-based rendering services, point cloud files with serialized point cloud data with semantic labels and measurement metadata for CAD integration through API endpoints, and 3D and 2D floorplans generated in various formats with dimensional annotations and semantic information for API distribution.

These outputs are structured for API consumption, enabling developers to integrate 3D reconstruction capabilities, semantic space analysis, measurement extraction, and contextual information retrieval into applications, web services, and automated workflows. The spatial language model functionality allows API users to perform sophisticated spatial queries, semantic analysis, measurement extraction, and contextual data integration for comprehensive built environment understanding.

The point cloud processing components integrate with the main AI training pipeline in several key ways. Enhanced input processing ensures that point cloud data processed through the geometric reconstruction modules provides geometrically validated inputs for AI model training. Semantic validation ensures that point cloud processing outputs serve as ground truth for validating AI-generated semantic labels and geometric reconstructions. Training data augmentation ensures that geometrically reconstructed models from point cloud processing provide additional training examples for the AI system. Quality metrics integration ensures that approximation rates and confidence scores from point cloud processing inform the loss functions used in AI model training.

The neural architecture employs a transformer-based architecture with mixed autoregressive and dense prediction components. The system utilizes convolutional feature extractors for initial image processing, followed by transformer layers that process spatial relationships and geometric constraints. The architecture supports variable input resolutions and aspect ratios through adaptive tokenization strategies that maintain spatial coherence across different image sizes. The neural reconstruction model employs multi-head attention mechanisms with learned positional encodings that incorporate 3D spatial relationships. The model architecture includes cross-attention layers that fuse information between multiple input views, enabling robust multi-view stereo reconstruction. The system implements skip connections and residual blocks throughout the network to maintain gradient flow and enable training of deep architectures. The computer vision models for semantic labeling utilize segmentation architectures based on vision transformers and convolutional neural networks. These models generate pixel-level semantic masks that identify architectural elements, structural components, and objects within input images. The segmentation results are integrated with the geometric reconstruction through learned alignment modules that ensure consistency between 2D semantic labels and 3D geometric outputs.

The scene coordinate system inference module implements mathematical transformations using homogeneous coordinates and rotation matrices. The system automatically determines the world-up direction of labeled floor and ceiling points, followed by computing the optimal rotation matrices for axis alignment. Scale factor determination occurs with known reference measurements or automatic estimation through semantic understanding of standard architectural elements.

The zone-based reconstruction module implements computational geometry algorithms including line-polygon intersection, Boolean operations on polygons, and spatial indexing for efficient zone generation. The system utilizes spatial indexing for rapid spatial queries and employs robust geometric predicates to handle numerical precision issues in geometric computations. Zone validation incorporates signed distance field computations and ray-casting algorithms for visibility determination.

The distributed training system implements data parallelism across multiple GPUs with gradient synchronization through all-reduce operations. The cluster-based training utilizes container orchestration for automatic scaling and resource allocation. The system implements checkpointing and model versioning through distributed storage systems, enabling fault tolerance and reproducible training runs.

The API system implements RESTful endpoints with data exchange formats. The spatial language model integration utilizes natural language processing models fine-tuned for architectural and spatial domain terminology. The API supports both synchronous and asynchronous processing modes, with WebSocket connections for real-time query processing and result streaming.

The measurement module implements geometric algorithms for computing volumes, surface areas, and distances in 3D space. The system utilizes triangulation algorithms for surface area computation and voxel-based methods for volume calculation. Distance measurements employ spatial indexing for efficient queries and geometric constraint satisfaction for maintaining measurement accuracy across coordinate system transformations.

The system implements data fusion algorithms that combine reconstructed geometric and semantic information with external databases through API calls and data synchronization protocols. The integration utilizes semantic matching algorithms to align reconstructed elements with external specifications and employs confidence weighting to balance internal reconstruction results with external data sources.

The present invention provides several technical advantages over prior art systems including iterative learning through feedback loops that continuously improve model accuracy through iterative refinement and retraining, semantic understanding integration that allows the system to make contextually appropriate adjustments to 3D models, metadata-driven training where comprehensive metadata annotation enables targeted improvements and better understanding of model deficiencies, scalable architecture where the modular design allows for scalable deployment and integration with existing workflows, multi-modal input support where the system can process various input types including images, point clouds, and textual descriptions, zone-based geometric reconstruction where the innovative zone-based approach provides advanced accuracy for complex room geometries compared to traditional edge-detection methods, automatic coordinate system alignment where intelligent coordinate system inference eliminates manual alignment requirements and ensures consistent geometric outputs, comprehensive quality metrics through multi-layered validation through confidence scoring, visibility sampling, approximation rate metrics, and custom quality assessments including ICP and IoU measurements ensures reliable reconstruction results, proprietary training innovations where advanced training methodologies including mixed-AR and DPT architecture, two-phase training protocols, and custom data augmentation techniques provide advanced performance compared to conventional 3D reconstruction approaches, production-ready data integration where incorporation of real-world production data, mobile capture data, and proprietary synthetic datasets ensures models are optimized for practical deployment scenarios, advanced architectural innovations where implementation of overcomplete estimation, unified single decoder architecture, and cluster-based training provides enhanced model performance and scalable training infrastructure, API integration and spatial intelligence where comprehensive API capabilities enable third-party integration while spatial language model functionality provides intelligent querying of built environments for diverse spatial analysis applications, including precise measurements, semantic classification, and external data integration for comprehensive contextual understanding, and spatial AI platform capabilities that provide foundation models and infrastructure for physical world applications across insurance, real estate, construction, robotics sectors, and more with low-compute requirements and device-agnostic operation.

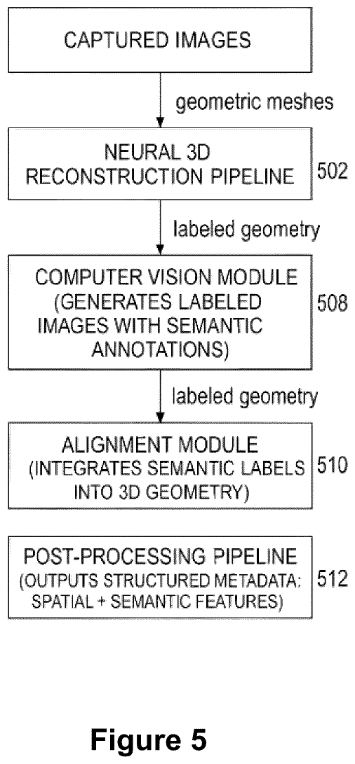

Referring to FIG. 5, the system begins with captured images that are processed by a neural 3D reconstruction pipeline (502). The neural 3D reconstruction pipeline (502) converts the captured images into 3D geometry meshes representing the spatial structure of the built environment. The generated geometric data is passed to a computer vision module (508), which produces labeled images with semantic annotations identifying architectural elements and other features. The labeled outputs from the computer vision module (508) are provided to an alignment module (510), which integrates the semantic labels into the 3D geometry to produce labeled 3D models with both spatial and semantic data. The labeled geometry is then processed by a post-processing pipeline (512), which generates structured metadata describing spatial and semantic features of the environment in a format suitable for integration with external systems and APIs. The flow of data between each module is represented by arrows, illustrating the sequential processing from raw image capture through reconstruction, semantic labeling, alignment, and metadata output.

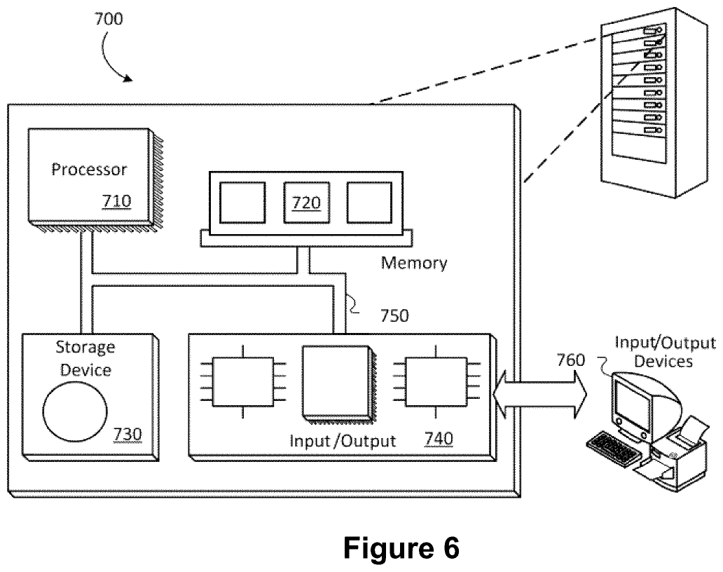

FIG. 6 depicts an example computing system, according to implementations of the present disclosure. The system 700 may be used for any of the operations described with respect to the various implementations discussed herein. The system 700 may include one or more processors 710, a memory 720, one or more storage devices 730, and one or more input/output (I/O) devices 760 controllable through one or more I/O interfaces 740. The various components 710, 720, 730, 740, or 760 may be interconnected through at least one system bus 750, which may enable the transfer of data between the various modules and components of the system 700.

The processor(s) 710 may be configured to process instructions for execution within the system 700. The processor(s) 710 may include single-threaded processor(s), multi-threaded processor(s), or both. The processor(s) 710 may be configured to process instructions stored in the memory 720 or on the storage device(s) 730. The processor(s) 710 may include hardware-based processor(s) each including one or more cores. The processor(s) 710 may include general purpose processor(s), special purpose processor(s), or both.

The memory 720 may store information within the system 700. In some implementations, the memory 720 includes one or more computer-readable media. The memory 720 may include any number of volatile memory units, any number of non-volatile memory units, or both volatile and non-volatile memory units. The memory 720 may include read-only memory, random access memory, or both. In some examples, the memory 720 may be employed as active or physical memory by one or more executing software modules.

The storage device(s) 730 may be configured to provide (e.g., persistent) mass storage for the system 700. In some implementations, the storage device(s) 730 may include one or more computer-readable media. For example, the storage device(s) 730 may include a floppy disk device, a hard disk device, an optical disk device, or a tape device. The storage device(s) 730 may include read-only memory, random access memory, or both. The storage device(s) 730 may include one or more of an internal hard drive, an external hard drive, or a removable drive. One or both of the memory 720 or the storage device(s) 730 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 700. In some implementations, the CRSM may include a data store that provides storage of computer-readable instructions or other information in a non-transitory format. The CRSM may be incorporated into the system 700 or may be external with respect to the system 700. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 710 and the memory 720 may be supplemented by, or incorporated into, one or more application-specific integrated circuits (ASICs).

The system 700 may include one or more I/O devices 760. The I/O device(s) 760 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 760 may also include one or more output devices such as a display, LED(s), an audio output device (e.g., a speaker), a printer, a haptic output device, and so forth. The I/O device(s) 760 may be physically incorporated in one or more computing devices of the system 700, or may be external with respect to one or more computing devices of the system 700. The system 700 may include one or more I/O interfaces 740 to enable components or modules of the system 700 to control, interface with, or otherwise communicate with the I/O device(s) 760. The I/O interface(s) 740 may enable information to be transferred in or out of the system 700, or between components of the system 700, through serial communication, parallel communication, or other types of communication. For example, the I/O interface(s) 740 may comply with a version of the RS-232 standard for serial ports, or with a version of the IEEE 1284 standard for parallel ports. As another example, the I/O interface(s) 740 may be configured to provide a connection over Universal Serial Bus (USB) or Ethernet. In some examples, the I/O interface(s) 740 may be configured to provide a serial connection that is compliant with a version of the IEEE 1394 standard.

The I/O interface(s) 740 may also include one or more network interfaces that enable communications between computing devices in the system 700, or between the system 700 and other network-connected computing systems. The network interface(s) may include one or more network interface controllers (NICs) or other types of transceiver devices configured to send and receive communications over one or more networks using any network protocol.

Computing devices of the system 700 may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 700 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects. This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them. A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently. Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return. Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system for generating semantically labeled 3D models, comprising:
a neural 3D reconstruction pipeline configured to process captured images into 3D geometry meshes;
a computer vision module configured to generate labeled images with semantic annotations;
an alignment module configured to integrate semantic labels into the 3D geometry to generate labeled 3D models; and
a post-processing pipeline configured to output structured metadata describing spatial and semantic features of a built environment.

2. The system of claim 1, wherein the computer vision module identifies walls, ceilings, doors, windows, floors, and furniture objects.

3. The system of claim 1, wherein the structured metadata includes room dimensions, spatial relationships, and architectural classifications.

4. The system of claim 1, further comprising an API interface for accessing labeled 3D models and semantic metadata programmatically.

5. A system for refining AI-generated 3D models, comprising:
a model evaluation module configured to detect discrepancies between generated 3D models and specification data;
a user interface configured to present discrepancies and receive manual adjustments from a human reviewer;
a metadata annotation system configured to record adjustment parameters and impacts; and
a feedback pipeline configured to compile adjusted models into a training dataset for AI model retraining.

6. The system of claim 5, wherein the user interface supports annotation, geometric correction, and semantic reclassification.

7. The system of claim 5, wherein the feedback pipeline tags training data with adjustment provenance and performance impact.

8. The system of claim 5, further comprising a model retraining module configured to minimize loss between adjusted and generated outputs.

9. A system for reconstructing room geometry from point cloud data, comprising:
a pointcloud processing module configured to assign semantic labels to 3D point cloud data from multiple frames;
a coordinate inference module configured to determine coordinate alignment and scale factors;
a geometric plane extraction module configured to identify signed planes from the point cloud data; and
a zone-based reconstruction module configured to define room boundaries based on Boolean operations on validated zones.

11. The system of claim 9, wherein the pointcloud processing module assigns confidence scores to each point based on label consistency across frames.

12. The system of claim 9, wherein the zone-based reconstruction module subdivides bounding boxes using extended wall plane segments and validates zones based on signed distances.
